(19) United States
(12) Patent Application Publication
(10) Pub. No.: US 2026/0106231 A1
(43) Pub. Date: Apr. 16, 2026

(54) RECHARGEABLE BATTERY WITH SHAPE MEMORY LAYER FOR ENHANCED SAFETY

(71) Applicant: Amionx, Inc., Carlsbad, CA (US)

(72) Inventors: Yanbo WANG, San Marcos, CA (US); Sambasiva Reddy BHEEMIREDDY, Fallbrook, CA (US); Jennifer KING, Carlsbad, CA (US); Hong YU, Carlsbad, CA (US); Evan SZUCH, Carlsbad, CA (US)

(21) Appl. No.: 19/116,790

(22) PCT Filed: Sep. 27, 2023
(86) PCT No.: PCT/US2023/075243

§ 371 Date: Mar. 28, 2025

Related U.S. Application Data
(60) Provisional application No. 63/377,513, filed on Sep. 28, 2022.

(51) Int. Cl. H01M 10/42; H01M 4/62; H01M 4/66; H01M 10/0525; H01M 10/0585; H01M 50/574; H01M 50/581; H01M 50/583

(52) U.S. Cl. CPC H01M 10/4235; H01M 4/622; H01M 4/625; H01M 4/626; H01M 4/661; H01M 4/667; H01M 10/0525; H01M 10/0585; H01M 50/574; H01M 50/581; H01M 50/583; H01M 2200/00; H01M 2200/10

(57) ABSTRACT

A battery cell may include a first electrode coupled with a first current collector, a second electrode coupled with a second current collector, and a separator interposed between the first electrode and the second electrode. The battery cell may further include a current controller including one or more shape memory effect (SME) materials in a deformed conformation. The shape memory effect (SME) materials may recover at least partially an original conformation of the shape memory effect (SME) materials in response to one or more stimuli. The current controller may have a lower conductivity when the shape memory effect (SME) materials are in the original conformation than when the shape memory effect (SME) materials are in the deformed conformation such that the shape memory effect (SME) materials recovering the original conformation reduces current flow within the battery cell.

### CROSS REFERENCE TO RELATED APPLICATION

This application claims priority to U.S. Provisional Application No. 63/377,513, entitled “RECHARGEABLE BATTERY WITH SHAPE MEMORY LAYER FOR ENHANCED SAFETY” and filed on Sep. 28, 2022, the disclosure of which is incorporated herein by reference in its entirety.

### TECHNICAL FIELD

The subject matter described herein relates generally to battery technology and more specifically to shape memory material based protective mechanisms for mitigating the hazards associated with overheating, internal short circuits, and overcharging in a battery cell.

### BACKGROUND

The high energy density and high current output of metal ion battery cells, such as lithium (Li) ion battery cells, render metal ion battery cells suitable for a variety of applications. However, metal ion battery cells are susceptible to various hazards during operation. For example, an overcurrent, a situation in which an excess current flows through the battery cell, can occur when the battery cell is overcharged and/or develops an internal short circuit. An internal short circuit typically occurs when the separator electrically isolating the anode from the cathode of the battery cell fails such that the anode and the cathode of the battery cell come into direct contact. In some cases, the separator of the battery cell can fail due to excessive mechanical stress, such as compressive shocks, that warps the internal morphology of the battery cell. Alternatively and/or additionally, the failure of the separator can be attributable to parasitic reactions, which occur during the routine charging and discharging of the battery cell. These parasitic reactions give rise to an irregular accumulation of metal ions on the anode of battery cell. The resulting dendrites can cause an internal short circuit when the dendrites penetrate the separator and makes contact with the cathode of the battery cell.

Whether the result of overheating, overcharging, or an internal short circuit, overcurrent can cause irreversible damage to the battery cell. Moreover, overcurrent can lead to thermal runaway, a dangerous condition in which undissipated heat from the overcharging battery cell accelerates exothermic reactions within the battery cell to further exacerbate the precipitous rise in the temperature of the battery cell. The consequences of thermal runaway are dire and can include, for example, combustion, explosion, and/or the like. In particular, a failed metal ion battery undergoing thermal runaway will release flammable gases, which make battery fires especially fast spreading and difficult to contain.

### SUMMARY

Systems, methods, and articles of manufacture, including battery cells and battery cell components, are provided. In some implementations of the current subject matter, there is provided a battery cell that includes: a first electrode coupled with a first current collector; a second electrode coupled with a second current collector; a separator interposed between the first electrode and the second electrode; and a current controller including one or more shape memory effect (SME) materials in a deformed conformation, the one or more shape memory effect (SME) materials recovering at least partially an original conformation of the one or more shape memory effect (SME) materials in response to one or more stimuli, the current controller having a lower conductivity when the one or more shape memory effect (SME) materials are in the original conformation than when the one or more shape memory effect (SME) materials are in the deformed conformation such that the one or more shape memory effect (SME) materials recovering the original conformation reduces current flow within the battery cell.

In some variations of the aforementioned systems, methods, and articles of manufacture, one or more of the following features can optionally be included in any feasible combination.

In some variations, the current controller may be disposed on at least one surface of the first electrode, the first current collector, the second electrode, the second current collector, and/or the separator.

In some variations, the one or more shape memory effect (SME) materials may be a binder in which a plurality of particles of active materials and/or conductive materials comprising the first electrode, the second electrode, and/or the separator are dispersed.

In some variations, the one or more shape memory effect (SME) materials may recover 1% to 100% of the original conformation.

In some variations, the one or more shape memory effect (SME) materials may include one or more of polyurethane (PU), epoxy, poly(ε-caprolactone) (PCL), poly(lactic acid) (PLA), poly(vinyl alcohol) (PVA), polyacrylate, polyethylene terephthalate (PET), polyether-ether-ketone (PEEK), polyvinylchloride (PVC), polyester (PE), polyethyleneoxide (PEO), and polymethyl methacrylate (PMMA).

In some variations, the one or more shape memory effect (SME) materials may form 1% to 99% of the current controller by weight.

In some variations, the one or more shape memory effect (SME) materials may form 10% to 90% of the current controller by weight.

In some variations, the one or more shape memory effect (SME) materials may form 20% to 70% of the current controller by weight.

In some variations, the current controller may further include one or more metal salts.

In some variations, the one or more metal salts may include at least one organic salt.

In some variations, the at least one organic salt may be a polyacid salt [—CR₂—(CR₂)₀₋₁₀₀-COOM-]ₚ, a polymethacrylic salt [—CR₂—(CR₂)₀₋₁₀₀—C(CR₃)(COOM)-]ₚ, a polyacrylate salt [—CR₂—(CR₂)₀₋₁₀₀—CR(COOM)-]ₚ, a polymethylmethacrylic salt [—CR(CR₃)—(CR₂)₀₋₁₀₀—C(CR₃)(COOM)-]ₚ, polyols-M [—CR₂—(CR₂)₀₋₁₀₀—CR-OM-]ₚ, polysulfide-M [—CR₂—(CR₂)₀₋₁₀₀—CR-SM-]ₚ, organic silicate [—R₂Si—O—SiR₂-]ₚ, wherein M is selected from a group of metals including Li, Na, K, Ca, Cd, Co, Cu, Fe, Ti, Ni, Zn, Mn, Pb, Sr and Zn, wherein R is selected from H, —CH₃, —CH₂CH₃ and other organic substitutes.

In some variations, the one or more metal salts may form 1% to 99% of the current controller by weight.

In some variations, the one or more metal salts may form 10% to 90% of the current controller by weight.

In some variations, the one or more metal salts may form 20% to 70% of the current controller by weight.

In some variations, the current controller may further include one or more inorganic nano materials.

In some variations, the one or more inorganic nano materials may include a metal carbonate, a metal hydrogen carbonate, a metal oxide, a metal titanate, a metal silicate, and/or a metal phosphate.

In some variations, the one or more inorganic nano materials may form 0.1% to 98.9% of the current controller by weight.

In some variations, the one or more inorganic nano materials may form 5% to 80% of the current controller by weight.

In some variations, the current controller further may include one or more conductive nano additives.

In some variations, the one or more conductive nano additives may include a carbon nano material, a carbon fiber, and/or a metallic powder.

In some variations, the one or more conductive nano additives may form 0.1% to 20% of the current controller by weight.

In some variations, the one or more conductive nano additives may form 0.5% to 10% of the current controller by weight.

In some variations, the one or more stimuli may include a temperature, a voltage, and/or a current of the battery cell.

In some variations, the deformed conformation of the one or more shape memory effect (SME) materials may be associated with at least one of a different shape and a different dimension than the original conformation the one or more shape memory effect (SME) materials.

In some variations, the current controller may exhibit a lower ionic conductivity and/or a lower electronic conductivity when the one or more shape memory effect (SME) materials are in the original conformation than when the one or more shape memory effect (SME) materials are in the deformed conformation.

In some variations, each of the first current collector and the second current collector may include a metal foil or a metallized polymeric foil.

In some variations, the separator may be a polymeric film or a ceramic film.

In some variations, the battery cell may be a metal ion battery cell.

In some variations, the battery cell may be a cylindrical cell, a prismatic cell, a pouch cell, or a button cell.

In some variations, the first electrode may be a positive electrode and the second electrode may be a negative electrode.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to metal ion battery cells such as lithium ion battery cells, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts a schematic diagram illustrating an example of a battery cell, in accordance with some example embodiments;

FIG. 1B depicts a schematic diagram illustrating another example of a battery cell, in accordance with some example embodiments;

FIG. 1C depicts a schematic diagram illustrating another example of a battery cell, in accordance with some example embodiments;

FIG. 2A depicts a schematic diagram illustrating an example of a shape memory effect (SME) material, in accordance with some example embodiments;

FIG. 2B depicts a schematic diagram illustrating another example of a shape memory effect (SME) material, in accordance with some example embodiments;

FIG. 2C depicts a schematic diagram illustrating another example of a shape memory effect (SME) material, in accordance with some example embodiments;

FIG. 3 depicts the chemical structures of an example of shape memory epoxy and of an example curing agent, in accordance with some example embodiments;

FIG. 4 depicts the chemical structure of an example of shape memory polyurethane (PU), in accordance with some example embodiments;

FIG. 5A depicts a graph illustrating the charge and discharge profiles of a battery cell with a shape memory epoxy current controller disposed on a cathode current collector, in accordance with some example embodiments;

FIG. 5B depicts a graph illustrating the charge and discharge profiles of a battery cell with a shape memory polyurethane (PU) current controller disposed on a cathode current collector, in accordance with some example embodiments;

FIG. 5C depicts a graph illustrating the charge and discharge profiles of a battery cell with a cathode having a shape memory polyurethane (PU) binder, in accordance with some example embodiments;

FIG. 5D depicts a graph illustrating the charge and discharge profiles of a baseline battery cell without a shape memory effect (SME) current controller, in accordance with some example embodiments;

FIG. 6A depicts a graph illustrating the thermal profile of a battery cell with a shape memory epoxy current controller disposed on a cathode current collector, in accordance with some example embodiments;

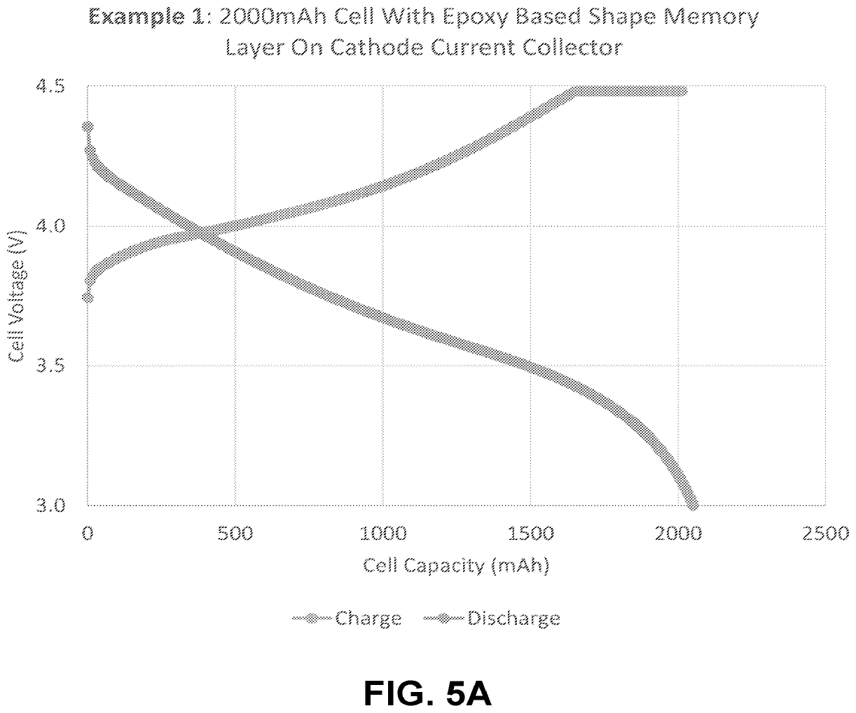

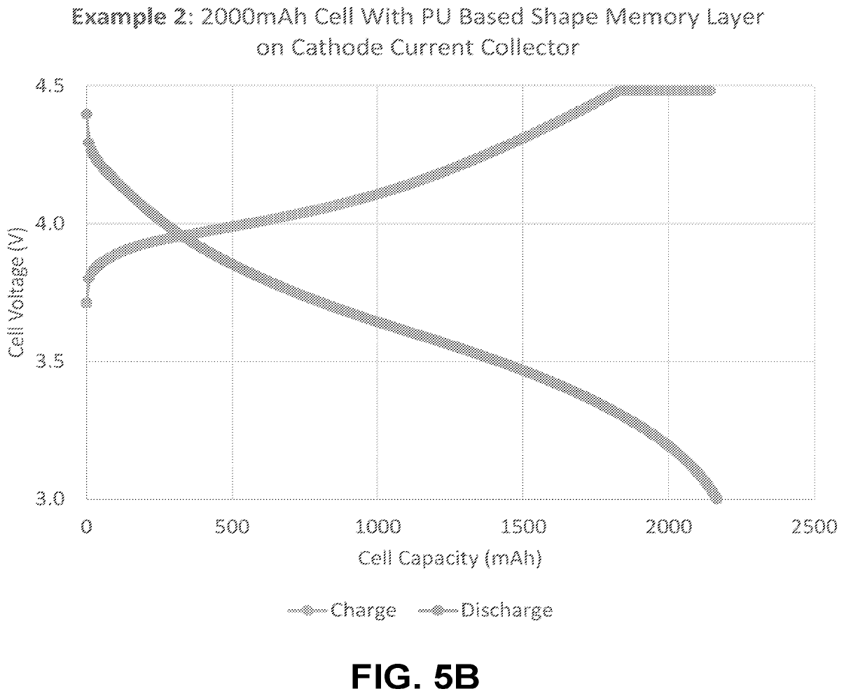

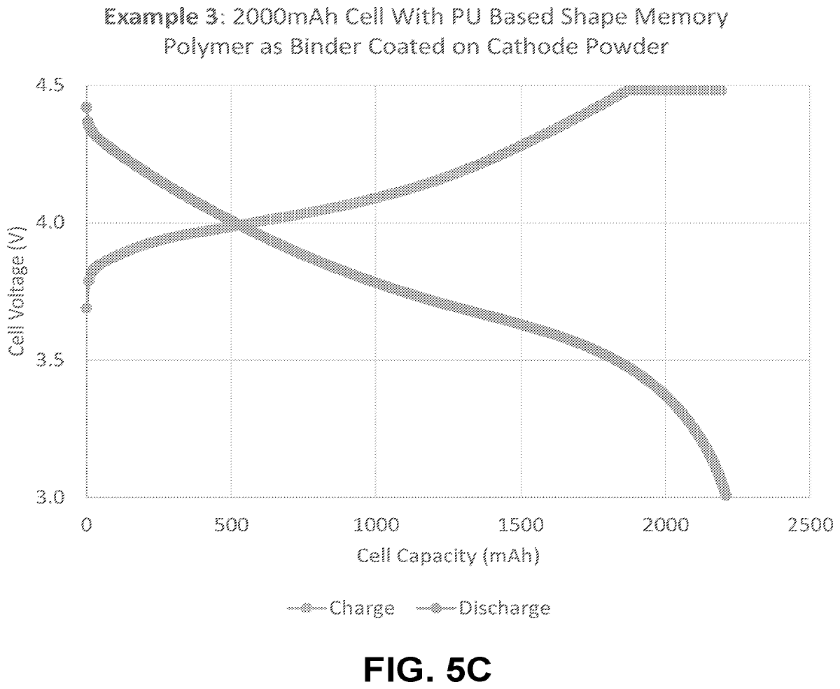

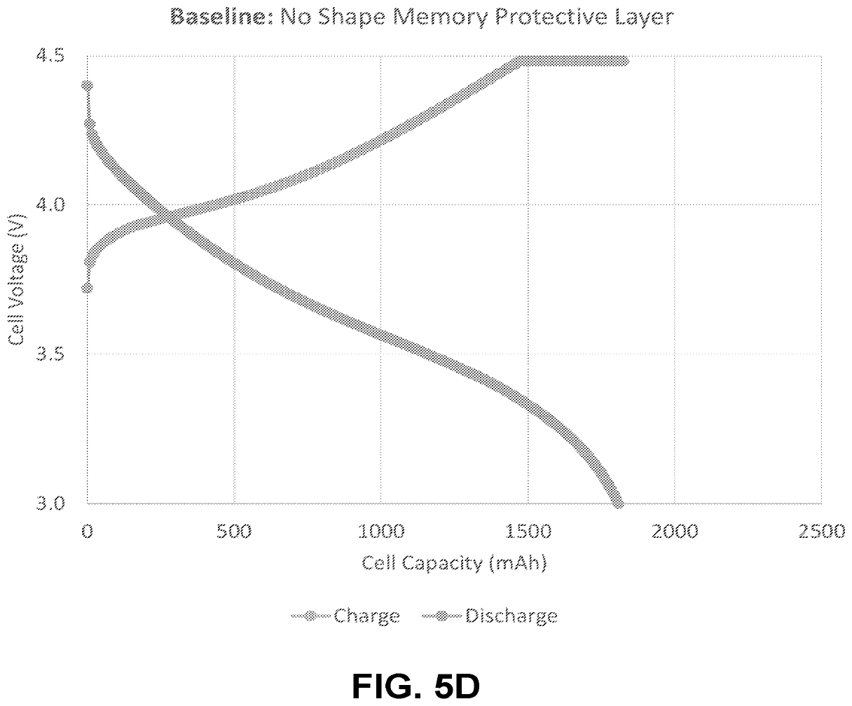

FIG. 5B depicts a graph illustrating the thermal profile of a battery cell with a shape memory polyurethane (PU) current controller disposed on a cathode current collector, in accordance with some example embodiments;

FIG. 5C depicts a graph illustrating the thermal profile of a battery cell with a cathode having a shape memory polyurethane (PU) binder, in accordance with some example embodiments; and

FIG. 5D depicts a graph illustrating the thermal profile of a baseline battery cell without a shape memory effect (SME) current controller, in accordance with some example embodiments.

When practical, similar reference numbers denote similar structures, features, or elements.

### DETAILED DESCRIPTION

A battery cell can overcharge, overheat, and/or short circuit during operation. For example, overcurrent can occur in a battery cell when the battery cell is overcharged and/or develops an internal short circuit. As noted, in some cases, the battery cell can develop an internal short circuit as the result of mechanical stress (e.g., compressive shocks) to the battery cell and/or the growth of dendrites that form a low resistivity path between the electrodes of the battery cell. Meanwhile, the battery cell can become overcharged when excess current is applied to battery cell, for example, while the battery cell is in already a fully charged state. Excess current flow in the battery cell, whether the result of an internal short circuit or overcharging, can cause irreversible damage to the battery cell. Overcurrent is often accompanied by an excessive generation of heat, which can culminate in a thermal runaway, a particularly hazardous condition in which an abrupt and uncontrolled increase in the temperature of the battery cell leads to fires, explosions, and/or the like. As such, in some implementations of the current subject matter, a battery cell may include one or more safety mechanisms to prevent overcurrent, thus mitigating and/or eliminating the hazards that arise from overheating, overcharging, and/or short circuiting the battery cell.

In some example embodiments, the one or more safety mechanisms may include a current controller that reduces or interrupts the flow of current within the battery cell when the temperature, current, and/or voltage of the battery cell satisfies one or more thresholds. The reduction or interruption of current flow when the battery cell reaches a threshold temperature, a threshold current, and/or a threshold voltage, such as a temperature, current, and/or voltage that is outside of the normal operational range of the battery cell, may mitigate and/or eliminate the hazards that arise from overheating, overcharging, and/or short circuiting. However, while the temperature, current, and/or voltage of the battery cell is within the normal operational range, the current controller should have minimal impact on the performance of the battery cell including, for example, charging and discharging rate of the battery cell. In particular, when the temperature, current, and/or voltage of the battery cell is outside of the normal operational range, the current controller may limit and/or interrupt current flow by at least increasing the resistivity within the battery cell. Contrastingly, while the temperature, current, and/or voltage of the battery cell remains within the normal operational range, the presence of the current controller should have minimal impact on the resistivity of the battery cell. Accordingly, in some example embodiments, the current controller may be formed from one or more materials, such as shape memory effect (SME) materials, that increase the resistivity within the battery cell when the temperature, current, and/or voltage of the battery cell is outside of the normal operational range. Otherwise, when the temperature, current, and/or voltage of the battery cell is within the normal operational range, the presence of such materials may have minimal impact on the resistivity within the battery cell, thus maximizing the safety as well as the performance profile of the battery cell. Shape memory effect (SME) materials are able to achieve greater conformational changes than mere thermal expansion. As such, a shape memory effect (SME) based current controller may be more effective at reducing and/or interrupting current flow within the battery cell when the battery cell is overcharged, overheats, and/or develops an internal short circuit.

In some example embodiments, the battery cell may include a current controller formed from one or more shape memory effect (SME) materials. As described in more detail below, a shape memory effect (SME) material may, subsequent to being deformed into a temporary conformation, recover its original conformation upon being exposed to one or more stimuli. Accordingly, in some cases, the battery cell may be formed with the current controller being deformed in a temporary conformation that is associated with a higher conductivity and/or a lower resistivity while the original conformation of the current controller is associated with a lower conductivity and/or higher resistivity. When the temperature, current, and/or voltage of the battery cell is within the normal operational range, the current controller may remain in the temporary conformation such that the current may flow within the battery cell with minimal resistivity and/or maximum conductivity. In some cases, the current controller may respond to exposure to one or more stimuli, such as a temperature, current, and/or voltage that is outside of the normal operational range of the battery cell, by at least reverting at least partially back to its original conformation, thus decreasing the conductivity and/or increasing the resistivity within the battery cell to limit and/or interrupt the flow of current therein.

In some example embodiments, the battery cell may include a first electrode (e.g., a positive electrode or a cathode) coupled with a first current collector, a second electrode (e.g., a negative electrode or an anode) coupled with a second current collector, and a separator interposed between the first electrode and the second electrode. In some cases, the current controller including the one or more shape memory effect (SME) materials may be interposed between the first electrode and the first current collector and/or the second electrode and the second current collector. Alternatively and/or additionally, the current controller including the one or more shape memory effect (SME) materials may be interposed between the separator and the first electrode or the second electrode the battery cell. In some cases, instead of being individual and discrete components within the battery cell, the current controller including the one or more shape memory effect (SME) materials may be integrated with the separator. For example, the separator of the battery cell may be formed to include the one or more shape memory effect (SME) materials and the resulting shape memory effect (SME) separator may be interposed between the first electrode and the second electrode of the battery cell.

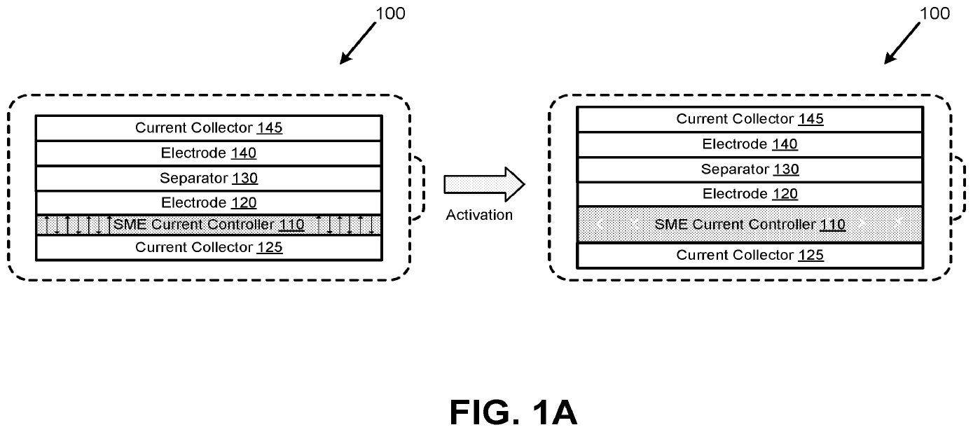

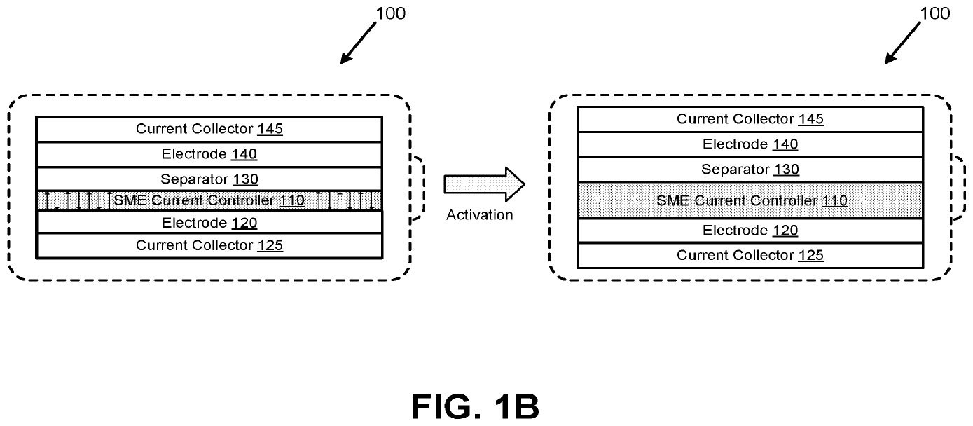

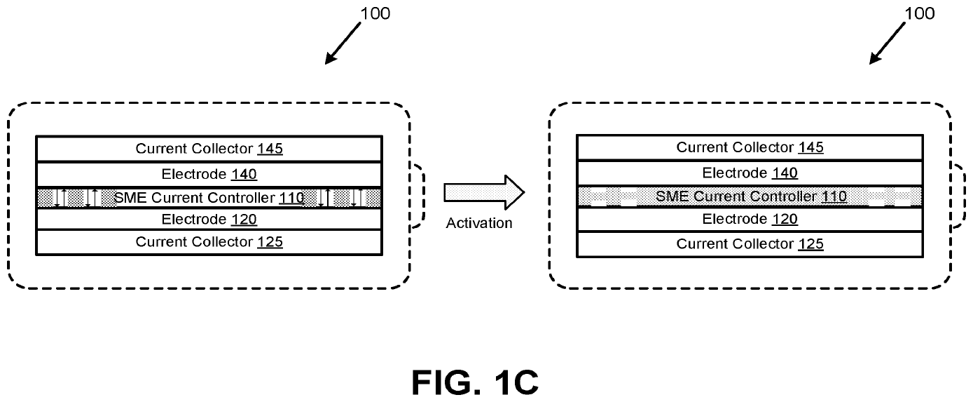

FIGS. 1A-C depict schematic diagrams illustrating examples of a battery cell 100 having a shape memory effect (SME) current controller 110 consistent with implementations of the current subject matter. In some implementations of the current subject matter, the battery cell 100 may be a metal-ion battery cell including, for example, a lithium (Li) ion battery cell, a sodium (Na) ion battery cell, an aluminum (Al) ion battery cell, a potassium (K) ion battery cell, and/or the like. Moreover, the battery cell 100 may have a variety of different formats including, for example, a cylindrical cell, a pouch cell, a prismatic cell, a button cell, and/or the like. As shown in FIGS. 1A-C, the battery cell 100 can include a first electrode 120 coupled with a first current collector 125, a second electrode 140 coupled with a second current collector 145, and a separator 130 (e.g., a polymeric film, a ceramic film, and/or the like) interposed between the first electrode 120 and the second electrode 140. The first electrode 120 may have an opposite polarity as the second electrode 140. For example, in some cases, the first electrode 120 may be a positive electrode (or a cathode) while the second electrode 140 is a negative electrode (or an anode). Alternatively, in some cases, the first electrode 120 may be a negative electrode (or an anode) while the second electrode 140 is a positive electrode (or a cathode). The first current collector 125 and the second current collector 145, which serve as electrical conductors between the electrodes and external circuits, may be formed from metal foils (e.g., copper (Cu) foil, aluminum (Al) foil, iron (Fe) foil, titanium (Ti) foil, nickel (Ni) foil, carbon (C) foil, stainless steel foil, and/or the like) and/or metallized polymeric foils.

In some example embodiments, the shape memory effect (SME) current controller 110 may be disposed on one or both surfaces of the first electrode 120, the first current collector 125, the separator 130, the second electrode 140, and/or the second current collector 145. To further illustrate, FIG. 1A depicts one example of the battery cell 100 in which the shape memory effect (SME) current controller 110 is interposed between the first electrode 120 and the first current collector 125. Alternatively and/or additionally, it should be appreciated that the shape memory effect (SME) current controller 110 may also be interposed between the second electrode 140 and the second current collector 145. In the example of the battery cell 100 shown in FIG. 1B, the shape memory effect (SME) current controller 110 is interposed between the first electrode 120 and the separator 130. Alternatively and/or additionally, the shape memory effect (SME) current controller 110 may be interposed between the separator 130 and the second electrode 140. In some cases, the shape memory effect (SME) current controller 110 may be integrated with the separator 130 or otherwise formulated to serve as a separator in place of the separator 130. An example of this configuration is shown in FIG. 1C where the shape memory effect (SME) current controller 110 is interposed between the first electrode 120 and the second electrode 140 of the battery cell 100. In some cases, the shape memory effect (SME) current controller 110 may also be integrated with the first electrode 120 and/or the second electrode 140. For example, in some cases, the first electrode 120 and/or the second electrode 140 may be formed by coating the corresponding active materials with one or more shape memory effect (SME) materials such that the first electrode 120 and/or the second electrode 140 includes particles of the active materials interspersed within the one or more shape memory effect (SME) materials.

In some example embodiments, the shape memory effect (SME) current controller 110 may include one or more shape memory effect (SME) materials. For example, in some cases, the shape memory effect (SME) current controller 110 may include 1% to 99%, 10% to 99%, or 20% to 70% by weight of the one or more shape memory effect (SME) materials. In some cases, the one or more shape memory effect (SME) material may include at least one polymer having a shape memory effect. Such polymers include polyurethane (PU), epoxy, poly(ε-caprolactone) (PCL), poly(lactic acid) (PLA), poly(vinyl alcohol) (PVA), polyacrylate, polyethylene terephthalate (PET), polyether-ether-ketone (PEEK), polyvinylchloride (PVC), polyester (PE), polyethyleneoxide (PEO), polymethyl methacrylate (PMMA), and/or the like. Examples of shape memory effect (SME) materials include shape memory polyurethane (PU) and nano composites thereof, shape memory epoxy polymer (EP) and nano composites thereof, shape memory poly(ε-caprolactone) (PCL) and nano composites thereof, shape memory poly(lactic acid) (PLA) and nano composites thereof, shape memory poly(vinyl alcohol) (PVA) and nano composites thereof, shape memory polyacrylate (PA) and nano composites thereof, shape memory polyethylene terephthalate (PET) and nano composites thereof, Shape memory polyethylene terephthalate (PET) and its nano composite, shape memory polyethyleneoxide (PEO) and nano composites thereof, shape memory polyether-ether-ketone (PEEK) and nano composites thereof, shape memory biodegradable polymers and nano composites thereof, shape memory polyester (PE) and nano composites thereof, shape memory polyvinylchloride (PVC) and nano composites thereof, and/or the like. Table 1 below enumerates additional examples of shape memory effect (SME) materials.

TABLE 1

| | |
|---|---|
| shape memory | carbon nanotube (CNT) based shape memory polyurethane (SMPU), carbon |
| polyurethane (PU) and | nanofiber (CNF) based shape memory polyurethane (SMPU), graphene based |
| nano composites thereof | shape memory polyurethane (SMPU), graphene oxide based shape memory |
| | polyurethane (SMPU), carbon black based shape memory polyurethane |
| | (SMPU), and metal powder based shape memory polyurethane (SMPU) |
| shape memory epoxy | carbon nanotube (CNT) based shape memory epoxy polymer (SMEP), carbon |
| polymer and nano | nanofiber (CNF) based shape memory epoxy polymer (SMEP), graphene based |
| composites thereof | shape memory epoxy polymer (SMEP), graphene oxide based shape memory |
| | epoxy polymer (SMEP), carbon black based shape memory epoxy polymer |
| | (SMEP), and metal powder based shape memory epoxy polymer (SMEP) |
| shape memory poly(ε- | carbon nanotube (CNT) based shape memory poly(ε-caprolactone) (SMPCL), |
| caprolactone) (PCL) and | carbon nanofiber (CNF) based shape memory poly(ε-caprolactone) (SMPCL), |
| nano composites thereof | graphene based shape memory poly(ε-caprolactone) (SMPCL), graphene oxide |
| | based shape memory poly(ε-caprolactone) (SMPCL), carbon black based shape |
| | memory poly(ε-caprolactone) (SMPCL), and metal powder shape memory |
| | poly(ε-caprolactone) (SMPCL) |
| shape memory poly(lactic | carbon nanotube (CNT) based shape memory poly(lactic acid) (SMPLA), |
| acid) (PLA) and nano | carbon nanofiber (CNF) based shape memory poly(lactic acid) (SMPLA), |
| composites thereof | graphene based shape memory poly(lactic acid) (SMPLA), graphene oxide |
| | based shape memory poly(lactic acid) (SMPLA), carbon black based shape |
| | memory poly(lactic acid) (SMPLA), and metal powder based shape memory |
| | poly(lactic acid) (SMPLA) |
| shape memory poly(vinyl | carbon nanotube (CNT) based shape memory poly(vinyl alcohol) (SMPVA), |
| alcohol) (PVA) and nano | carbon nanofiber (CNF) based shape memory poly(vinyl alcohol) (SMPVA), |
| composites thereof | graphene based shape memory poly(vinyl alcohol) (SMPVA), graphene oxide |
| | based shape memory poly(vinyl alcohol) (SMPVA), carbon black based shape |
| | memory poly(vinyl alcohol) (SMPVA), and metal powder based shape |
| | memory poly(vinyl alcohol) (SMPVA) |
| shape memory | carbon nanotube (CNT) based shape memory polyacrylate (SMPA), carbon |
| polyacrylate and nano | nanofiber (CNF) based shape memory polyacrylate (SMPA), graphene based |
| composites thereof | shape memory polyacrylate (SMPA), graphene oxide based shape memory |
| | polyacrylate (SMPA), carbon black based shape memory polyacrylate |
| | (SMPA), and metal powder based shape memory polyacrylate (SMPA) |

In some example embodiments, the shape memory effect (SMVE) current controller 110 may include one or more metal salts in addition to the one or more shape memory effect (SMVE) materials. In some cases, the one or more metal salts may include at least one organic salt such as, for example, polyacid salts [—CR₂—(CR₂)₀₋₁₀₀-COOM-]ₚ, polymethacrylic salts [—CR₂—(CR₂)₀₋₁₀₀—C(CR₃)(COOM)-]ₚ, polyacrylate salts [—CR₂—(CR₂)₀₋₁₀₀—CR(COOM)-]ₚ, polymethylmethacrylic salts [—CR(CR₃)—(CR₂)₀₋₁₀₀—C(CR₃)(COOM)-]ₚ, polyols-M [—CR₂—(CR₂)₀₋₁₀₀—CR-OM-]ₚ, polysulfide-M [—CR₂—(CR₂)₀₋₁₀₀—CR-SM-]ₚ, organic silicate [—R₂Si—O-SiR₂-]ₚ, wherein M is selected from a group of metals including Li, Na, K, Ca, Cd, Co, Cu, Fe, Ti, Ni, Zn, Mn, Pb, Sr and Zn, wherein R is selected from H, —CH₃, —CH₂CH₃ and other organic substitutes. Moreover, in some cases, the shape memory effect (SME) current controller 110 may include 1% to 99%, 10% to 90%, or 20% to 70% of the one or more metal salts by weight.

In some example embodiments, in addition to the one or more shape memory effect (SME) materials, the shape memory effect (SME) current collector 110 may also include one or more inorganic nano materials. For example, in some cases, the shape memory effect (SME) current collector 110 may include 0.1% to 98.9% or 5% to 80% of the one or more inorganic nano materials by weight. Moreover, in some cases, the one or more inorganic nano materials may include at least one inorganic nano material having at least one dimensions that is smaller than 500 nanometers. Alternatively and/or additionally, the one or more inorganic nano materials may include at least one inorganic nano material having at least one dimensions that is smaller than 100 nanometers. Examples of the one or more inorganic nano materials include metal carbonate (e.g., Li₂CO₃, Na₂CO₃, K₂CO₃, CaCO₃, BeCO₃, MgCO₃, SrCO₃, BaCO₃, FeCO₃), metal hydrogen carbonate (e.g., LiHCO₃, NaHCO₃, KHCO₃, CsHCO₃, Ca(HCO₃)₂, Mg(HCO₃)₂), metal oxide (e.g., CaO, MgO, SiO₂, Al₂O₃, TiO₂, ZrO₂, CuO, SnO₂, GeO₂, C₀₃₀₄, ZnO), metal titanate (e.g., Li₂TiO₃, CaTiO₃, MgTiO₃, BaTiO₃, ZnTiO₃), metal silicate (e.g., Li₂SiO₃, Na₂SiO₃, MgSiO₃, CaSiO₃, FeSO₃, MnSiO₃, K₂SiO₃, Zn₂SiO₄, Mg₂SiO₄, Fe₂SiO₄, Mn₂SiO₄, ZrSiO₄, Be₂SiO₄), metal phosphate (e.g., FePO₄, Ca₃(PO₄)₂, Na₃PO₄, Li₃PO₄, LiFePO₄, NaFePO₄), and/or the like.

In some example embodiments, in addition to the one or more shape memory effect (SME) materials, the shape memory effect (SME) current collector 110 may also include one or more conductive nano additives. For example, in some cases, the shape memory effect (SME) current collector 110 may include 0.1% to 20% or 0.5% to 10% of the one or more conductive nano additives by weight. Moreover, in some cases, the one or more conductive nano additives may include at least one conductive nano additive having at least one dimensions that is smaller than 500 nanometers. Alternatively and/or additionally, the one or more conductive nano additive may include at least one conductive nano additive having at least one dimensions that is smaller than 100 nanometers. Examples of the one or more conductive nano additives include carbon nano materials and carbon fibers (e.g., graphene, graphene oxide, carbon black; single/multi wall carbon nano tubes), metallic powders (e.g., copper (Cu), aluminum (Al), silver (Ag), gold (Au), titanium (Ti), nickel (Ni), magnesium (Mg)), and combinations thereof.

In some example embodiments, the shape memory effect (SME) current controller 110 may transition between an original conformation (e.g., an original shape, one or more original dimensions, and/or the like) and a temporary conformation (e.g., a temporary shape, one or more temporary dimensions, and/or the like). In some cases, the battery cell 100 may be formed with the shape memory effect (SME) current controller 110 being deformed in the temporary conformation. For example, the shape memory effect (SME) current controller 110 may be exposed to low temperature and/or high pressure during the formation of the battery cell 100, such as during the calendaring process to form the first electrode 120 and/or the second electrode 140 of the battery cell 100, which causes the shape memory effect (SME) current controller 110 to transition from its original conformation to the temporary conformation. While the temperature, current, and/or voltage of the battery cell 100 is within a normal operational range, the shape memory effect (SME) current controller 110 may remain in the temporary conformation. However, upon exposure to one or more stimuli, such as when the temperature, current, and/or voltage of the battery cell satisfy one or more thresholds, the shape memory effect (SME) current controller 110 may revert at least partially back to its original conformation. That is, the exposure to the one or more stimuli may cause the shape memory effect (SME) current controller 110 to return to recover anywhere from 1% to 100% of its original conformation. For instance, in some cases, the temperature of the battery cell 100 may increase when the battery cell 100 is overcharged and/or develops a short circuit. The shape memory effect (SME) current controller 110 may be activated, which includes the shape memory effect (SME) current controller 110 recovering its original conformation, when the temperature of the battery cell 100 exceeds a certain threshold.

In some example embodiments, the shape memory effect (SME) current controller 110 in its original conformation may exhibit a lower conductivity and/or higher resistivity than the shape memory effect (SME) current controller 110 in its temporary conformation. As such, while the shape memory effect (SME) current controller 110 is in its temporary conformation may permit current to flow therethrough with maximum conductivity and/or minimal resistivity, the shape memory effect (SME) current controller 110 may limit or interrupt this current flow when the shape memory effect (SME) current controller 110 reverts at least partially back to its original conformation.

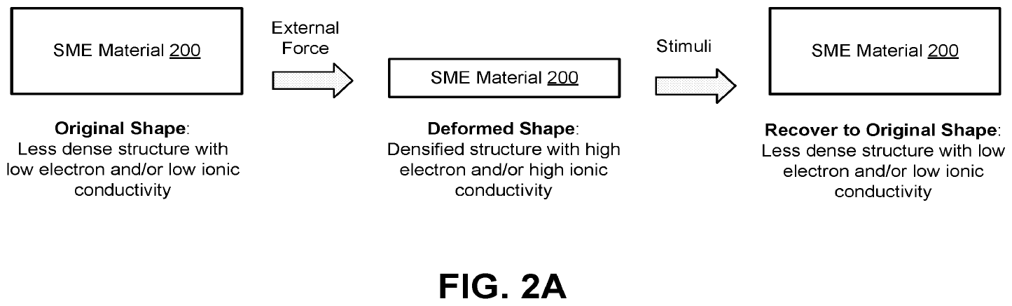

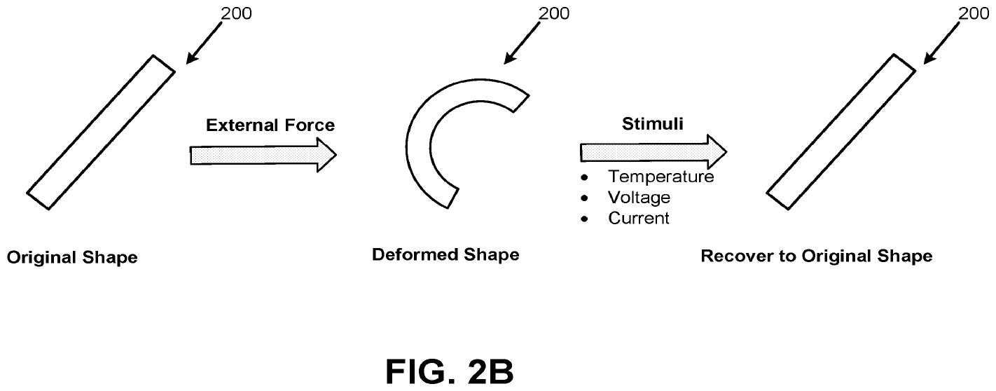

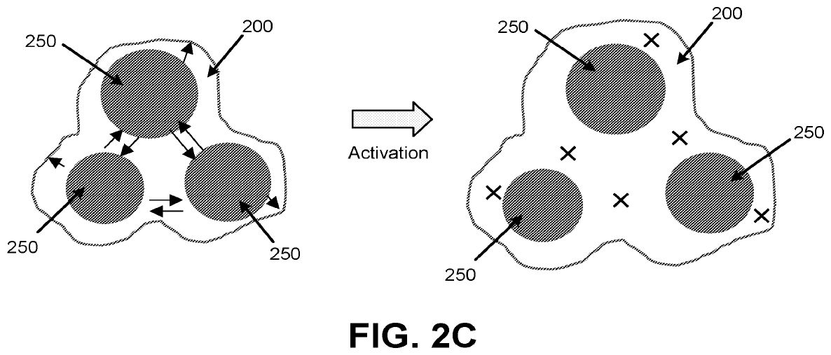

In some example embodiments, the shape memory effect (SME) current controller 110 may undergo transition between an original conformation and a temporary conformation due to phase changes in the underlying crystal structure of the constituent shape memory effect (SME) materials. For example, while the shape memory effect (SME) current controller 110 is in its original conformation, the molecules of the shape memory effect (SME) materials may be in an alpha phase in which the molecules are in an organized crystal state supported by partial hydrogen bonds. However, exposure to certain stimuli, including temperature, magnetic fields, electric fields, light, moisture, acidity or alkalinity, redox reactions, enzymes, and mechanical stress, may cause these partial hydrogen bonds to break and the molecules of the shape memory effect (SME) materials to transition to a beta phase in which the molecules are randomly organized in a glass state. To further illustrate, FIG. 2A depicts a schematic diagram illustrating an example of a shape memory effect (SME) material 200 transitioning between an original conformation that is associated with a less dense structure of lower electron conductivity and/or lower ionic conductivity and a deformed conformation that is associated with a more densified structure of higher electron conductivity and/or higher ionic conductivity. In the example shown in FIG. 2A, the shape memory effect (SME) material 200 may transition from its original conformation to the deformed conformation upon being exposed to an external force. Furthermore, the shape memory effect (SME) material 200 in the deformed conformation may recover its original conformation when exposed to certain stimuli such as excessive temperature, voltage, current, and/or the like. While the example of the shape memory effect (SME) material 200 undergoes a change in thickness as the shape memory effect (SME) material 200 transitions between the original conformation and the deformed conformation, FIG. 2B depicts another example of the shape memory effect (SME) material 200 in which the transition between the original conformation and the deformed conformation is manifest as a change in the shape of the shape memory effect (SME) material 200.

In some example embodiments, the shape memory effect (SME) current controller 110 formed from the shape memory effect (SME) material 200 may exhibit a higher level of electronic conductivity and/or ionic conductivity when the shape memory effect (SME) material 200 is in the temporary (or deformed) conformation than when the shape memory effect (SME) material 200 is in the original conformation at least because the conductive paths that exist while the shape memory effect (SME) material 200 is in the temporary (or deformed) conformation are reduced or eliminated when the shape memory effect (SME) material 200 is in the original conformation. To further illustrate, FIG. 2C depicts a schematic diagram of an example of the shape memory effect (SME) current controller 110 in which particles of a active material 250 are interspersed amongst the shape memory effect (SME) material 200. In instances where the shape memory effect (SME) current controller 110 is disposed on either or both surfaces of the first current collector 125 and/or the second current collector 145, the active material 250 may be a electronically conductive material. Contrastingly, in instances where the shape memory effect (SME) controller 110 is interposed between the first current collector 120 and the second current collector 140, the active material 250 may be an ionically conductive material. As shown in FIG. 2C, the conductive paths (e.g., for electrons, ions, and/or the like) that exist while the shape memory effect (SME) material 200 is in the temporary (or deformed) conformation are reduced or eliminated when the shape memory effect (SME) material 200 is in the original conformation. Accordingly, when the shape memory effect (SME) material 200 reverts back at least partially to its original conformation, the shape memory effect (SME) current controller 110 may limit and/or interrupt the flow of current within the battery cell 100 by at least limiting and/or interrupting the flow of ions and/or electrons through the battery cell 100.

Table 2 below shows the conformation changes for an epoxy based shape memory effect (SME) current controller 110 and a polyurethane (PU) based shape memory effect (SME) current controller 110. In the example shown in Table 2, the conformation changes exhibited by the shape memory effect (SME) current controller 110 is quantified in changes in the thickness of the shape memory effect (SME) current controller 110 after calendaring to achieve its temporary conformation and after being subjected to a stimuli in the form of heating to revert back to its original conformation. Table 2 also shows that the concomitant changes in resistance (e.g., the through plane resistance of a 5 centimeter by 5 centimeter sheet), which corresponds to the extent to which the shape memory effect (SME) limits the flow of current through the battery cell 100.

TABLE 2

| | | | % | Resistance | | | |
|---|---|---|---|---|---|---|---|
| | | Thickness | Reduction | at | Thickness | Shape | Resistance |
| | Original | After | in | Reduced | After | Recovery | After |
| SME | Thickness | Calendaring | Thickness | Thickness | Heating | Ratio | Recovery |
| Epoxy | 5.64 μm | 4.12 μm | 26.95% | 65.2Ω | 4.83 μm | 85.64% | 109.65Ω |
| | (Avg. of | (Avg. of 12) | | (Avg. of 3) | | | |
| | 12) | | | | | | |
| PU | 3.94 μm | 2.5 μm | 36.55% | 5.55Ω | 2.69 μm | 68.27% | 9.91Ω |
| | (Avg. of 8) | (Avg. of 8) | | (Avg. of 3) | | | |

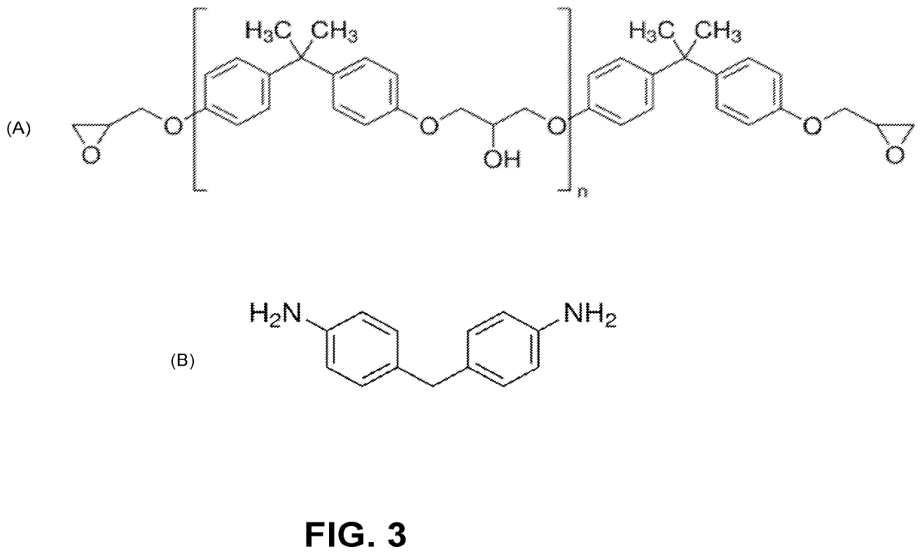

Example Battery Cell I: Example Battery Cell I includes a shape memory epoxy polymer (EP) coated on the cathode current collector. The cathode of Example Battery Cell I is formed by mixing epoxy E51 (Poly(Bisphenol A-co-epichlorohydrin) (FIG. 3(A)), glycidyl end-capped) with N-methyl pyrrolidone (NMP) until the epoxy is fully dissolved. Super-p nano powder is then added to the mixture and mixed at high-speed to achieve uniform dispersion. A curing agent, such as 4,4′-Diamino diphenylmethane (FIG. 3(B)), is mixed with N-methyl pyrrolidone (NMP) until it is fully dissolved. The two mixtures are combined and further mixed until uniformly dispersed. The final composition of the resulting epoxy slurry includes 66% epoxy, 29% curing agent, and 5% super-p. The solid content of the epoxy slurry is 15% by weight. This epoxy slurry is coated on aluminum (Al) foil, for example, by a gravure rod, before being dried at 120° C. to evaporate the N-methyl pyrrolidone (NMP). The same process may be repeated in order to coat the other side of the aluminum (Al) foil with the same epoxy slurry. The epoxy is cured at a 90% ratio to achieve a trigger temperature in the range of 100-130° C.

A slurry of cathode material is coated on the aluminum (Al) foil coated with the dried epoxy slurry. The composition of the cathode slurry is 98% lithium cobalt oxide (LiCoO₂) (LCO), 1% polyvinylidene fluoride (PVDF), and 1% conductive additive. The areal loading of the cathode layer is controlled at approximately 20 milligrams per square centimeter for both sides while the compact density is around 4.1 grams per cubic centimeters after the calendaring process. A 2000 milliamp-hour (mAh) pouch cell is formed to include the foregoing cathode for evaluation of safety performance, for example, relative to a baseline battery cell without a shape memory effect (SME) based safety mechanism.

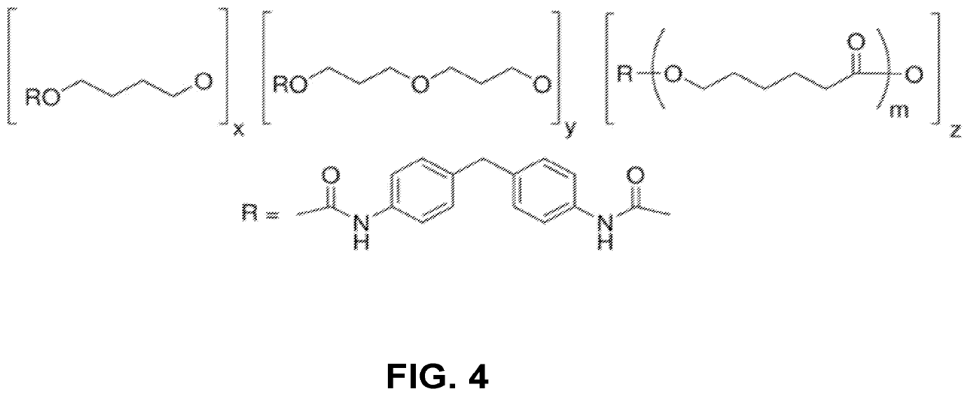

Example Battery Cell II: Example Battery Cell II includes a shape memory polyurethane (PU) coated cathode current collector. The cathode of Example Battery Cell II is formed by mixing poly (4,4′-methylenebis(phenyl isocynanate)-alt-1,4-butanediol/di(propylene glycol)/polycaprolactone (FIG. 4) with N-methyl pyrrolidone (NMP) until it is fully dissolved. Super-p nano powder is then added to the mixture and mixed at high speed to achieve uniform dispersion before calcium carbonate (CaCO₃) nano powder is added to the mixture and mixed at high-speed until uniformly dispersed. The final composition of the polyurethane slurry is 85% polyurethane, 10% calcium carbonate (CaCO₃), and 5% super-p. The solid content of the polyurethane (PU) slurry is 5.88% by weight prior to coating. The polyurethane (PU) slurry is coated onto aluminum (Al) foil, for example, by a gravure rod, and dried at 120° C. to evaporate the N-methyl pyrrolidone (NMP). The same process is repeated in order to coat the other side of the aluminum (Al) foil with the same polyurethane (PU) slurry.

A slurry of cathode material is coated on the aluminum (Al) foil coated with the dried epoxy slurry. The composition of the cathode slurry is 98% lithium cobalt oxide (LiCoO₂) (LCO), 1% polyvinylidene fluoride (PVDF), and 1% conductive additive. The areal loading of the cathode layer is controlled at approximately 20 milligrams per square centimeter for both sides while the compact density is around 4.1 grams per cubic centimeters after the calendaring process. A 2000 milliamp-hour (mAh) pouch cell is formed to include the foregoing cathode for evaluation of safety performance, for example, relative to a baseline battery cell without a shape memory effect (SME) based safety mechanism.

Example Battery Cell III: Example Battery Cell III includes shape memory polyurethane (PU) incorporated with cathode materials. In particular, particles of cathode materials may be interspersed within poly (4,4′-methylenebis(phenyl isocynanate)-alt-1,4-butanediol/di(propylene glycol)/polycaprolactone, which acts as a binder coating the particles of cathode materials. The poly (4,4′-methylenebis(phenyl isocynanate)-alt-1,4-butanediol/di(propylene glycol)/polycaprolactone is gradually dissolved in N-methyl pyrrolidone (NMP) before a conductive nano additive powder is added to the solution and mixed at high speed until uniform dispersion is achieved. Thereafter, lithium cobalt oxide (LiCoO₂) (LCO) powder may be added to the solution and mixed until uniformly dispersed. The resulting cathode slurry is cast onto bare aluminum (Al) foil to form the cathodes. The composition of cathode is 98% lithium cobalt oxide (LiCoO₂) (LCO), 1% polyurethane (PU), and 1% conductive additive. The areal loading of the cathode layer is controlled at approximately 20 milligrams per square centimeter for both sides while the compact density is around 4.1 grams per cubic centimeter after calendaring process. A 2000 milliamp-hour (mAh) pouch cell is formed to include the foregoing cathode for evaluation of safety performance, for example, relative to a baseline battery cell without a shape memory effect (SME) based safety mechanism.

Table 3 depicts a comparison of the resistivity change in the cathodes of Example Battery Cell I, Example Battery Cell II, Example Battery Cell III, and a baseline electrode (without a shape memory effect (SME) based safety mechanism) prior to and after exposure to a stimulus (e.g., heat). The results shown in Table 3 are consistent with the fact that shape memory effect (SME) materials, such as epoxy and polyurethane, are able to achieve greater conformational changes when recovering their original conformations than mere thermal expansion. As such, the conformational changes of shape memory effect (SME) materials are accompanied by more significant increase in the internal resistivity of a battery cell incorporating a shape memory effect (SME) based current controller.

TABLE 3

| | | | Thru-Plane | |
|---|---|---|---|---|
| | | 5 cm × 5 cm Thru- | Resistance After | Resistance |
| | Description | Plane Resistance | 130° C. Exposure | Increase Ratio |
| Electrode from | Shape memory epoxy on | 49.6Ω | 65.18Ω | 31.41% |
| Example I | cathode current collector | (Avg. of 3) | (Avg. of 3) | |
| Electrode from | Shape memory PU on | 2.12Ω | 4.62Ω | 117.92% |
| Example II | cathode current collector | (Avg. of 3) | (Avg. of 3) | |
| Electrode from | Cathode powder | 97.86Ω | 124.33Ω | 27.05% |
| Example III | interspersed in shape | (Avg. of 3) | (Avg. of 3) | |
| | memory PU acting as binder | | | |
| Baseline | No shape memory effect | 2.78Ω | 2.84Ω | 2.16% |
| Electrode | material, PVDF as binder | (Avg. of 3) | (Avg. of 3) | |

Table 4 shows the a comparison of the cell performance and nail penetration test results for Example Battery Cell I, Example Battery Cell II, Example Battery Cell III, and a baseline battery cell (without a shape memory effect (SME) based safety mechanism). As shown in Table 4, all three battery cells with a shape memory effect (SME) based current controller successfully passed the nail penetration test, indicating a significant improvement in the safety profile of the battery cell. In particular, the impedance of the battery cells with a shape memory effect (SME) based current controller increased after nail penetration in response to the short circuit created by the nail penetration and the precipitous temperature increase caused by the concomitant release of energy. This increase in temperature activates the shape memory effect (SME) material to recover its original shape, which is associated with greater resistivity and/or lower conductivity. As such, the shape memory effect (SME) material limits and/or interrupts the flow of current within the battery cell, reducing the release of energy associated with the short circuit, and prevents the battery cell from undergoing thermal runaway.

TABLE 4

| | | Cell | Cell | Cell | Cell | |
|---|---|---|---|---|---|---|
| | | Voltage | Impedance | Voltage | Impedance | |
| | Cell | Prior | Prior | After | After | |
| | Discharge | to Nail | to Nail | Nail | Nail | Re- |
| | Capacity | Test | Test | Test | Test | sults |
| Example | 2052 mAh | 4.365 V | 34.9 mΩ | 4.233 V | 38.1 mΩ | Pass |
| Cell I | | | | | | |
| Example | 2167 mAh | 4.357 V | 12.16 mΩ | 3.952 V | 20.6 mΩ | Pass |
| Cell II | | | | | | |
| Example | 2210 mAh | 4.355 V | 16.68 mΩ | 4.328 V | 30.6 mΩ | Pass |
| Cell III | | | | | | |
| Baseline | 1807 mAh | 4.355 V | 10.79 mΩ | — | — | Fail |
| Cell | | | | | | |

FIGS. 5A-D depicts graphs illustrating the charge and discharge profiles of Example Battery Cell I (with a shape memory epoxy current controller disposed on the cathode current collector), Example Battery Cell II (with a shape memory polyurethane (PU) current controller disposed on the cathode current collector), Example Battery Cell III (with a shape memory polyurethane (PU) binder in the cathode), and a baseline battery cell (without a shape memory effect (SME) based safety mechanism). As shown in FIGS. 5A-D, the battery cells with a shape memory effect (SME) based safety mechanism exhibit similar charge and discharge profiles as the baseline battery cell. This comparison indicates that in the absence of stimuli and while the shape memory effect (SME) materials remain in their temporary (or deformed) conformation, the presence of shape memory effect (SME) materials have minimal impact on the charge and discharge rates of a battery cell.

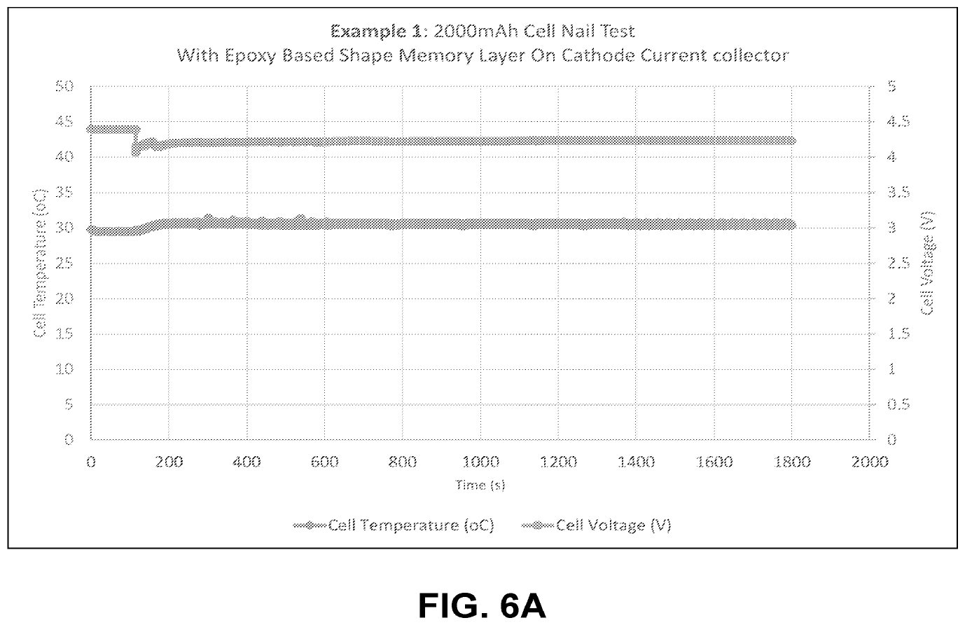

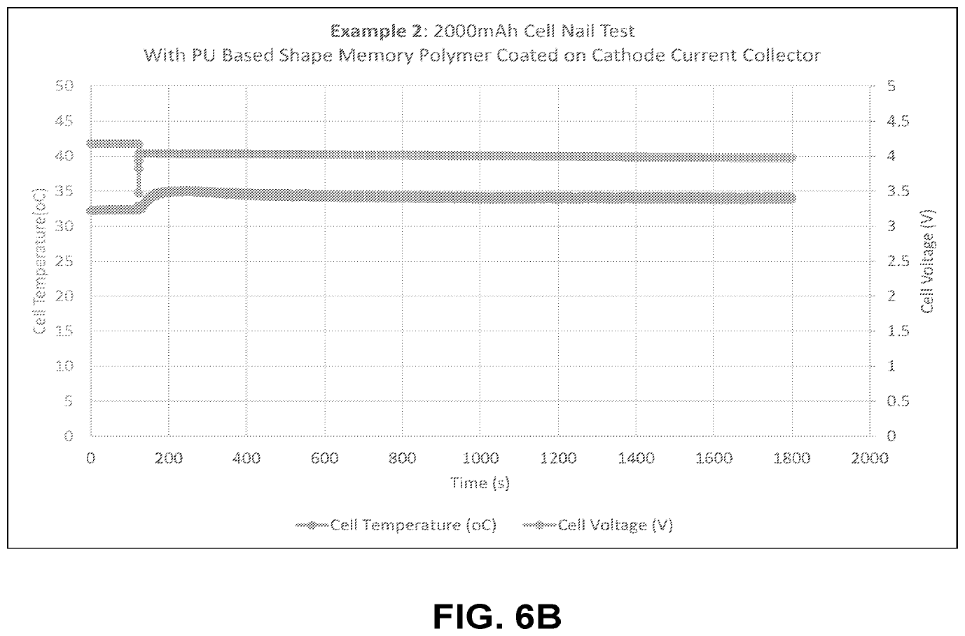

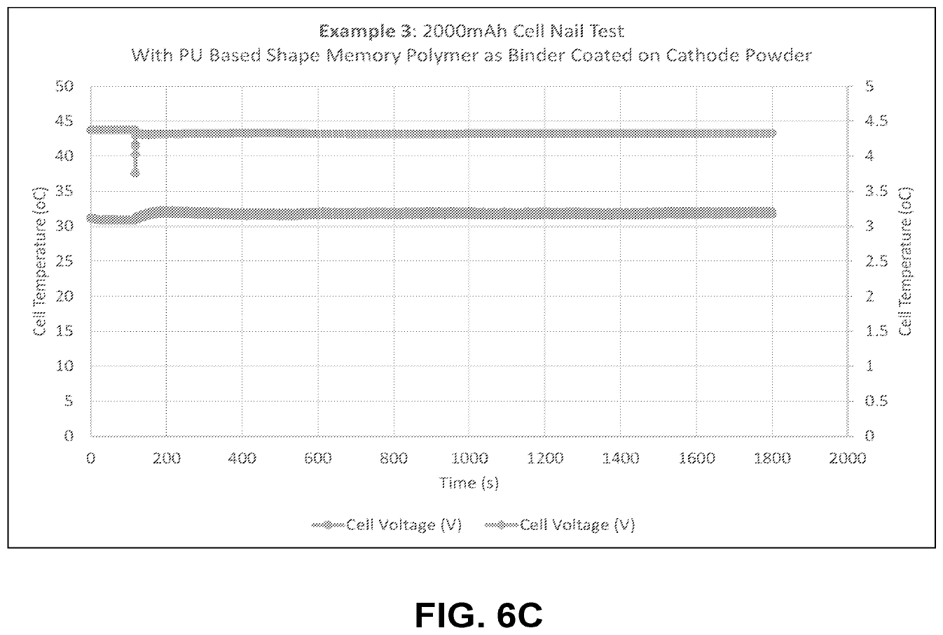

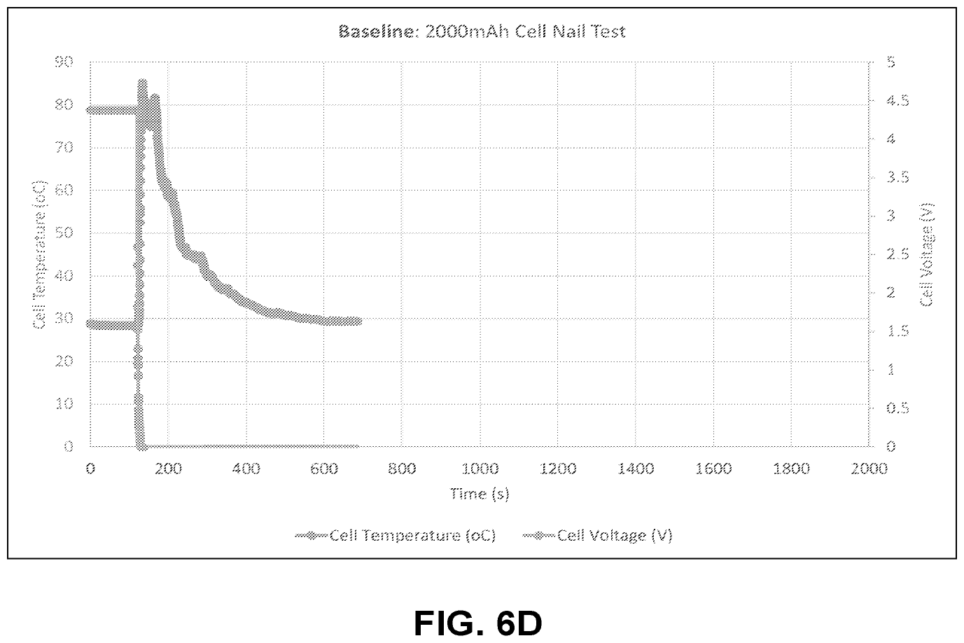

FIGS. 6A-D depicts graphs illustrating the results of the nail penetration test for Example Battery Cell I (with a shape memory epoxy current controller disposed on the cathode current collector), Example Battery Cell II (with a shape memory polyurethane (PU) current controller disposed on the cathode current collector), Example Battery Cell III (with a shape memory polyurethane (PU) binder in the cathode), and a baseline battery cell (without a shape memory effect (SME) based safety mechanism). The graphs shown in FIGS. 6A-D correspond to the thermal profiles of the corresponding battery cell during the nail penetration test. As shown in FIGS. 6A-C, Example Battery Cell I, II, and III passed the nail penetration test, with each battery cell showing only a slight voltage drop and a slight temperature increase, which are consistent with the shape memory epoxy current controller interrupting current flow to thwart a significant energy release and temperature increase. Contrastingly, FIG. 6D shows that the voltage of the baseline battery cell dropped immediately while the temperature of the baseline battery cell increased precipitously until an explosion occurred.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Item 1: A battery cell, comprising: a first electrode coupled with a first current collector; a second electrode coupled with a second current collector; a separator interposed between the first electrode and the second electrode; and a current controller including one or more shape memory effect (SME) materials in a deformed conformation, the one or more shape memory effect (SME) materials recovering at least partially an original conformation of the one or more shape memory effect (SME) materials in response to one or more stimuli, the current controller having a lower conductivity when the one or more shape memory effect (SME) materials are in the original conformation than when the one or more shape memory effect (SME) materials are in the deformed conformation such that the one or more shape memory effect (SME) materials recovering the original conformation reduces current flow within the battery cell.

Item 2: The battery cell of Item 1, wherein the current controller is disposed on at least one surface of the first electrode, the first current collector, the second electrode, the second current collector, and/or the separator.

Item 3: The battery cell of any of Items 1 to 2, wherein the one or more shape memory effect (SME) materials are a binder in which a plurality of particles of active materials and/or conductive materials comprising the first electrode, the second electrode, and/or the separator are dispersed.

Item 4: The battery cell of any of Items 1 to 3, wherein the one or more shape memory effect (SME) materials recovers 1% to 100% of the original conformation.

Item 5: The battery cell of any of Items 1 to 4, wherein the one or more shape memory effect (SME) materials include one or more of polyurethane (PU), epoxy, poly(ε-caprolactone) (PCL), poly(lactic acid) (PLA), poly(vinyl alcohol) (PVA), polyacrylate, polyethylene terephthalate (PET), polyether-ether-ketone (PEEK), polyvinylchloride (PVC), polyester (PE), polyethyleneoxide (PEO), and polymethyl methacrylate (PMMA).

Item 6: The battery cell of any of Items 1 to 5, wherein the one or more shape memory effect (SME) materials comprise 1% to 99% of the current controller by weight.

Item 7: The battery cell of any of Items 1 to 5, wherein the one or more shape memory effect (SME) materials comprise 10% to 90% of the current controller by weight.

Item 8: The battery cell of any of Items 1 to 5, wherein the one or more shape memory effect (SME) materials comprise 20% to 70% of the current controller by weight.

Item 9: The battery cell of any of Items 1 to 8, wherein the current controller further includes one or more metal salts.

Item 10: The battery cell of Item 9, wherein the one or more metal salts include at least one organic salt.

Item 11: The battery cell of Item 10, wherein the at least one organic salt is a polyacid salt [—CR₂—(CR₂)₀₋₁₀₀-COOM-]ₚ, a polymethacrylic salt [—CR₂—(CR₂)₀₋₁₀₀—C(CR₃)(COOM)-]ₚ, a polyacrylate salt [—CR₂—(CR₂)₀₋₁₀₀—CR(COOM)-]ₚ, a polymethylmethacrylic salt [—CR(CR₃)—(CR₂)₀₋₁₀₀—C(CR₃)(COOM)-]ₚ, polyols-M [—CR₂—(CR₂)₀₋₁₀₀—CR-OM-]ₚ, polysulfide-M [—CR₂—(CR₂)₀₋₁₀₀—CR-SM-]ₚ, organic silicate [—R₂Si—O—SiR₂-]ₚ, wherein M is selected from a group of metals including Li, Na, K, Ca, Cd, Co, Cu, Fe, Ti, Ni, Zn, Mn, Pb, Sr and Zn, wherein R is selected from H, —CH₃, —CH₂CH₃ and other organic substitutes.

Item 12: The battery cell of any of Items 9 to 11, wherein the one or more metal salts comprise 1% to 99% of the current controller by weight.

Item 13: The battery cell of any of Items 9 to 11, wherein the one or more metal salts comprise 10% to 90% of the current controller by weight.

Item 14: The battery cell of any of Items 9 to 11, wherein the one or more metal salts comprise 20% to 70% of the current controller by weight.

Item 15: The battery cell of any of Items 1 to 14, wherein the current controller further includes one or more inorganic nano materials.

Item 16: The battery cell of Item 15, wherein the one or more inorganic nano materials include a metal carbonate, a metal hydrogen carbonate, a metal oxide, a metal titanate, a metal silicate, and/or a metal phosphate.

Item 17: The battery cell of any of Items 15 to 16, wherein the one or more inorganic nano materials comprise 0.1% to 98.9% of the current controller by weight.

Item 18: The battery cell of any of claims 15 to 16, wherein the one or more inorganic nano materials comprise 5% to 80% of the current controller by weight.

Item 19: The battery cell of any of Items 1 to 18, wherein the current controller further includes one or more conductive nano additives.

Item 20: The battery cell of Item 19, wherein the one or more conductive nano additives include a carbon nano material, a carbon fiber, and/or a metallic powder.

Item 21: The battery cell of any of Items 19 to 20, wherein the one or more conductive nano additives comprise 0.1% to 20% of the current controller by weight.

Item 22: The battery cell of any of Items 19 to 20, wherein the one or more conductive nano additives comprise 0.5% to 10% of the current controller by weight.

Item 23: The battery cell of any of Items 1 to 22, wherein the one or more stimuli include a temperature, a voltage, and/or a current of the battery cell.

Item 24: The battery cell of any of Items 1 to 23, wherein the deformed conformation of the one or more shape memory effect (SME) materials is associated with at least one of a different shape and a different dimension than the original conformation the one or more shape memory effect (SME) materials.

Item 25: The battery cell of any of Items 1 to 24, wherein the current controller exhibits a lower ionic conductivity and/or a lower electronic conductivity when the one or more shape memory effect (SME) materials are in the original conformation than when the one or more shape memory effect (SME) materials are in the deformed conformation.

Item 26: The battery cell of any of Items 1 to 25, wherein each of the first current collector and the second current collector comprises a metal foil or a metallized polymeric foil.

Item 27: The battery cell of any of Items 1 to 26, wherein the separator is a polymeric film or a ceramic film.

Item 28: The battery cell of any of Items 1 to 27, wherein the battery cell is a metal ion battery cell.

Item 29: The battery cell of any of Items 1 to 28, wherein the battery cell is a cylindrical cell, a prismatic cell, a pouch cell, or a button cell.

Item 30: The battery cell of any of Items 1 to 29, wherein the first electrode is a positive electrode and the second electrode is a negative electrode.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A battery cell, comprising:
a first electrode coupled with a first current collector;
a second electrode coupled with a second current collector;
a separator interposed between the first electrode and the second electrode; and
a current controller including one or more shape memory effect (SME) materials in a deformed conformation, the one or more shape memory effect (SME) materials recovering at least partially an original conformation of the one or more shape memory effect (SME) materials in response to one or more stimuli, the current controller having a lower conductivity when the one or more shape memory effect (SME) materials are in the original conformation than when the one or more shape memory effect (SME) materials are in the deformed conformation such that the one or more shape memory effect (SME) materials recovering the original conformation reduces current flow within the battery cell.

2. The battery cell of claim 1, wherein the current controller is disposed on at least one surface of the first electrode, the first current collector, the second electrode, the second current collector, and/or the separator.

3. The battery cell of claim 1, wherein the one or more shape memory effect (SME) materials are a binder in which a plurality of particles of active materials and/or conductive materials comprising the first electrode, the second electrode, and/or the separator are dispersed.

4. (canceled)

5. The battery cell of claim 1, wherein the one or more shape memory effect (SME) materials include one or more of polyurethane (PU), epoxy, poly(ε-caprolactone) (PCL), poly(lactic acid) (PLA), poly(vinyl alcohol) (PVA), polyacrylate, polyethylene terephthalate (PET), polyether-ether-ketone (PEEK), polyvinylchloride (PVC), polyester (PE), polyethyleneoxide (PEO), and polymethyl methacrylate (PMMA).

6. The battery cell of claim 1, wherein the one or more shape memory effect (SME) materials comprise 1% to 99%, 10% to 90%, or 20% to 70% of the current controller by weight.

7. (canceled)

8. (canceled)

9. The battery cell of claim 1, wherein the current controller further includes one or more metal salts.

10. The battery cell of claim 9, wherein the one or more metal salts include at least one organic salt, and wherein the at least one organic salt is one of a polyacid salt [—CR₂—(CR₂)₀₋₁₀₀-COOM-]ₚ, a polymethacrylic salt [—CR₂—(CR₂)₀₋₁₀₀—C(CR₃)(COOM)-]ₚ, a polyacrylate salt [—CR₂—(CR₂)₀₋₁₀₀—CR(COOM)-]ₚ, a polymethylmethacrylic salt [—CR(CR₃)—(CR₂)₀₋₁₀₀—C(CR₃)(COOM)-]ₚ, polyols-M [—CR₂—(CR₂)₀₋₁₀₀—CR-OM-]ₚ, polysulfide-M [—CR₂—(CR₂)₀₋₁₀₀—CR-SM-]ₚ, organic silicate [—R₂Si—O—SiR₂-]ₚ, wherein M is selected from a group of metals including Li, Na, K, Ca, Cd, Co, Cu, Fe, Ti, Ni, Zn, Mn, Pb, Sr and Zn, wherein R is selected from H, —CH₃, —CH₂CH₃ and other organic substitutes.

11. (canceled)

12. The battery cell of claim 9, wherein the one or more metal salts comprise 1% to 99%, 10% to 99%, or 20% to 70% of the current controller by weight.

13. (canceled)

14. (canceled)

15. The battery cell of claim 1, wherein the current controller further includes one or more inorganic nano materials, and wherein the one or more inorganic nano materials include a metal carbonate, a metal hydrogen carbonate, a metal oxide, a metal titanate, a metal silicate, and/or a metal phosphate.

16. (canceled)

17. The battery cell of claim 15, wherein the one or more inorganic nano materials comprise 0.1% to 98.9% or 5% to 80% of the current controller by weight.

18. (canceled)

19. The battery cell of claim 1, wherein the current controller further includes one or more conductive nano additives, and wherein the one or more conductive nano additives include a carbon nano material, a carbon fiber, and/or a metallic powder.

20. (canceled)

21. The battery cell of claim 19, wherein the one or more conductive nano additives comprise 0.1% to 20% or 0.5% to 10% of the current controller by weight.

22. (canceled)

23. The battery cell of claim 1, wherein the one or more stimuli include a temperature, a voltage, and/or a current of the battery cell.

24. The battery cell of claim 1, wherein the deformed conformation of the one or more shape memory effect (SME) materials is associated with at least one of a different shape and a different dimension than the original conformation the one or more shape memory effect (SME) materials.

25. The battery cell of claim 1, wherein the current controller exhibits a lower ionic conductivity and/or a lower electronic conductivity when the one or more shape memory effect (SME) materials are in the original conformation than when the one or more shape memory effect (SME) materials are in the deformed conformation.

26. The battery cell of claim 1, wherein each of the first current collector and the second current collector comprises a metal foil or a metallized polymeric foil.

27. The battery cell of claim 1, wherein the separator is a polymeric film or a ceramic film.

28. The battery cell of claim 1, wherein the battery cell is a metal ion battery cell.

29. The battery cell of claim 1, wherein the battery cell is a cylindrical cell, a prismatic cell, a pouch cell, or a button cell.

30. The battery cell of claim 1, wherein the first electrode is a positive electrode and the second electrode is a negative electrode.
